(19) United States
(12) Patent Application Publication
(10) Pub. No.: US 2014/0190993 A1
(43) Pub. Date: Jul. 10, 2014

(54) SYSTEM OF CONTAINERS HAVING INTERCHANGEABLE COMPONENTS AND METHOD OF MANUFACTURING THE SAME

(71) Applicant: John C. Crawford, Mahopac, NY (US)

(72) Inventor: John C. Crawford, Mahopac, NY (US)

(73) Assignee: COLGATE-PALMOLIVE COMPANY, New York, NY (US)

(21) Appl. No.: 14/233,639

(22) PCT Filed: Jul. 21, 2011
(86) PCT No.: PCT/US2011/044878

§ 371 Date: Jan. 17, 2014

(51) Int. Cl. B65D 47/06; B29C 65/56

(52) U.S. Cl. CPC B65D 47/06; B29C 65/56
USPC 222/129; 53/449

(57) ABSTRACT

The present invention, in one aspect, is directed to a system of containers having interchangeable container bodies (110, 210) and closures (150, 250). The system comprises at least two container bodies having different three-dimensional geometries and at least two closures having different three-dimensional geometries. Each of the closures comprises a fitment that can be coupled to a coupling structure (130, 230) of each of the container bodies, thereby affording each of the closures the ability to be coupled to each of the container bodies, and vice versa. As a result, the formation of only two different closures and two different container bodies results in the ability to create four different containers by simply rearranging the closure/container body combination.

### FIELD OF THE INVENTION

The present invention relates to containers, and specifically to containers that include separate components, such as a container body and a closure that are coupled together to create a desired aesthetic.

### BACKGROUND OF THE INVENTION

The distribution of personal care products, such as body washes, lotions, liquid soaps, and other flowable products in multi-component containers is known in the art. In one type of known multi-component container, the container comprises two separate components, namely a container body and a closure. The closure is coupled to the container body, typically through an operable mating between a coupling structure of the container body and a fitment of the closure. The closure often includes a lid for opening and closing a dispensing orifice that is in fluid communication with the passageway of the nozzle.

In existing containers that include a container body and a closure, the coupling structure of the container body and the fitment of the closure are specifically designed to operably mate only with one another. As a result, the container body of any specific container can only be coupled with the single closure that is specifically designed for that particular container. Thus, existing containers do not allow manufacturers to provide aesthetically different containers without creating different molds and retooling. While efforts have been made to create aesthetically different closures that can be used on the same container body, these efforts fall short in that they are limited by the aesthetics of the single container body. As a result, the potential number of aesthetically different containers is limited.

Therefore, a need exists for a system of containers that allows manufacturers to combine a plurality of aesthetically different closures with a plurality of aesthetically different container bodies, thereby maximizing the number of achievable aesthetically different containers.

### BRIEF SUMMARY OF THE INVENTION

The present invention, in one aspect, is directed to a system of containers having interchangeable container bodies and closures. The system comprises at least two container bodies having different three-dimensional geometries and at least two closures having different three-dimensional geometries. Each of the closures comprises a fitment that can be coupled to a coupling structure of each of the container bodies, thereby affording each of the closures the ability to be coupled to each of the container bodies, and vice versa. As a result, the formation of only two different closures and two different container bodies results in the ability to create four different containers by simply rearranging the closure/container body combination.

In one embodiment, the invention can be a system of containers having interchangeable components comprising: a first container body comprising: a first product containing portion; a first shoulder portion having a first annular edge; and a first nozzle; a second container body comprising: a second product containing portion; a second shoulder portion having a second annular edge; and a second nozzle; a first closure comprising: a first closure body; and a first fitment, the first closure body comprising: a first closure wall having a first dispensing orifice; a first lid for opening and closing the first dispensing orifice; and a first annular skirt terminating in a third annular edge; a second closure comprising: a second closure body; and a second fitment, the second closure body comprising: a second closure wall having a second dispensing orifice; a second lid for opening and closing the second dispensing orifice; and a second annular skirt terminating in a fourth annular edge; each of the first product containing portion, the second product containing portion, the first closure body, and the second closure body having a three-dimensional geometry that is different from one another; and each of the first, second, third, and fourth annular edges having a configuration that is substantially identical to one another; the first fitment configured to: (1) couple the first closure to the first container body so that the first and third annular edges mate with one another and the first dispensing orifice is in fluid communication with a passageway of the first nozzle, thereby creating a first container; and (2) in the alternative, couple the first closure to the second container body so that the second and third annular edges mate with one another and the first dispensing orifice is in fluid communication with a passageway of the second nozzle, thereby creating a second container; and the second fitment configured to: (1) couple the second closure to the first container body so that the first and fourth annular edges mate with one another and the second dispensing orifice is in fluid communication with the passageway of the first nozzle, thereby creating a third container; and (2) in the alternative, couple the second closure to the second container body so that the second and fourth annular edges mate with one another and the second dispensing orifice is in fluid communication with the passageway of the second nozzle, thereby creating a fourth container.

In another embodiment, the invention can be a system of containers having interchangeable components comprising: a first container body comprising: a first product containing portion having a first three-dimensional geometry; and a first nozzle; a second container body comprising: a second product containing portion having a second three-dimensional geometry; and a second nozzle; a first closure comprising: a first closure body having a third three-dimensional geometry; and a first fitment; a second closure comprising: a second closure body having a fourth three-dimensional geometry; and a second fitment; each of the first, second, third and fourth three-dimensional geometries being different from one another; the first fitment configured to: (1) couple the first closure to the first container body to create a first container; and (2) in the alternative, couple the first closure to the second container body to create a second container; and the second fitment configured to: (1) couple the second closure to the first container body to create a third container; and (2) in the alternative, couple the second closure to the second container body to create a fourth container.

In yet another embodiment, the invention can be a system of containers having interchangeable components comprising: a first container body comprising: a first product containing portion having a first three-dimensional geometry; and a first coupling structure; a second container body comprising: a second product containing portion having a second three-dimensional geometry; and a second coupling structure that is substantially identical to the first coupling structure; a first closure comprising: a first closure body having a third three-dimensional geometry; and a first fitment; a second closure comprising: a second closure body having a fourth three-dimensional geometry; and a second fitment that is substantially identical to the first coupling structure; each of the first, second, third and fourth three-dimensional geometries being different from one another; and wherein each of the first and second fitments can be coupled to each of the first and second coupling structures.

In still another embodiment, the invention can be a method of manufacturing four containers comprising: a) forming a plurality of first container bodies comprising: a first product containing portion having a first three-dimensional geometry; a first nozzle, and a first coupling structure; b) forming a plurality of second container bodies comprising: a second product containing portion having a second three-dimensional geometry; a second nozzle; and a second coupling structure; c) forming a plurality of first closures comprising: a first closure body having a third three-dimensional geometry; and a first fitment; d) forming a plurality of second closures comprising: a second closure body having a fourth three-dimensional geometry; and a second fitment; wherein each of the first, second, third and fourth three-dimensional geometries are different from one another; and (e) coupling one of the first and second closures to one of the first and second container bodies via operable mating between the first or second fitment and the first or second coupling structure to form a container.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a first container according to one embodiment of the present invention;

FIG. 2 is a perspective view of a second container according to one embodiment of the present invention;

FIG. 3 is a perspective view of a third container according to one embodiment of the present invention;

FIG. 4 is a perspective view of a fourth container according to one embodiment of the present invention;

FIG. 5 is a rear view of the universal shoulder portion that is provided on both container bodies that are used in the containers of FIGS. 1-4 according to one embodiment of the present invention;

FIG. 6 is a perspective view of the universal shoulder portion of FIG. 5;

FIG. 7 is a longitudinal cross-sectional view of the first container of FIG. 1;

FIG. 8 is a longitudinal cross-sectional view of the second container of FIG. 2;

FIG. 9 is a longitudinal cross-sectional view of the third container of FIG. 3; and

FIG. 10 is a longitudinal cross-sectional view of the fourth container of FIG. 4.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

In the description of embodiments of the invention disclosed herein, any reference to direction or orientation is merely intended for convenience of description and is not intended in any way to limit the scope of the present invention. Moreover, the features and benefits of the invention are illustrated by reference to exemplified embodiments. Accordingly, the invention expressly should not be limited to such exemplified embodiments illustrating some possible but non-limiting combination of features that may be provided alone or in other combinations of features; the scope of the invention being defined by the claims appended hereto.

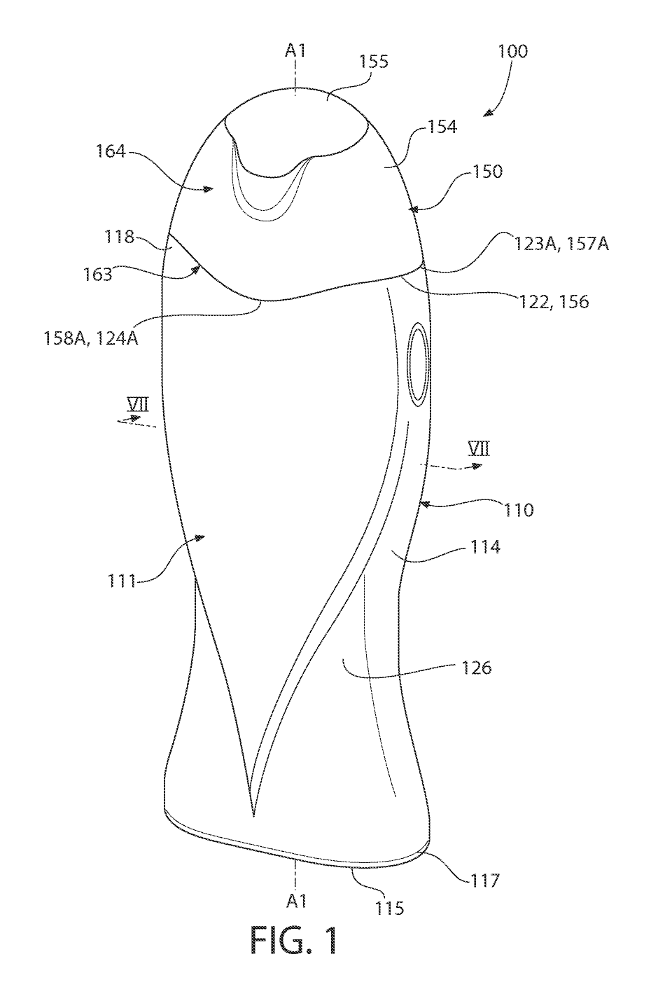

Referring first to FIGS. 1 and 5-7 concurrently, a first container 100 in accordance with one embodiment of the present invention is illustrated. The first container 100 generally comprises a first container body 110 and a first closure 150. The first closure 150 is coupled to the first container body 110 (as described in further detail below) to create the first container 100. In the exemplified embodiment, the first container 100 is a self-standing elongated container that extends along a longitudinal axis A1-A1.

The first container body 110 comprises a first product containing portion 111, a first shoulder portion 112 and a first nozzle 113. In the exemplified embodiment, the first product containing portion 111, the first shoulder portion 112 and the first nozzle 113 are an integrally formed unitary structure. However, in alternate embodiments, the first product containing portion 111, the first shoulder portion 112 and the first nozzle 113 can be formed as one or more separate components that are coupled together at a later stage of manufacturing via a thermal welding, sonic welding, adhesion, tight-fit assembly, or other coupling, fusion and/or bonding process.

The first container body 110 is preferably formed of a thermoplastic, such as polyethylene, polypropylene, polybutylene terephthalate, polyethylene terephthalate, polymethyl methacrylate, polystyrene, and polycarbonate, etc. The first container body 110 can be formed by standard thermoplastic forming techniques, such as blow-molding, injection molding, gas-assist injection molding, or combinations thereof.

The first product containing portion 111 comprises a first upstanding wall 114 and a first lower end wall 115 that, together with the first shoulder portion 112, collectively define a first product cavity 116 in which a first flowable product is stored. The first lower end wall 115 is a substantially flat wall that extends substantially normal to the longitudinal axis A1-A1. As a result, the first lower end wall 115 acts a support surface that allows the first container 100, when positioned on a horizontal surface, to assume a self-supporting upright orientation. The first lower end wall 115 seals a bottom end of the first product cavity 116 so that the first flowable product contained within the first product cavity 116 does not leak therefrom.

The first product containing portion 111 extends from a first lower end 117 to a first upper end 118. The first lower end wall 115 is located at the first lower end 117 of the first product containing portion 111. At the first upper end 118 of the first product containing portion 111, the first container body 110 transitions into the first shoulder portion 112. The first shoulder portion 112 extends radially inward from the first upper end 118 of the first product containing portion 111. The first nozzle 113 protrudes from the first shoulder portion 112, extending in a longitudinal direction away from the first product containing portion 111.

The first nozzle 113 is a tubular structure extending from a base 127 to a top edge 128 and defining a first passageway 119 that is in fluid communication with the first product cavity 116. Thus, the first flowable product can be dispensed from the first product cavity 116 through the first passageway 119. In one embodiment, the first upstanding wall 114 of the first product containing portion 111 is compressible radially inward so that the first product can be dispensed from the first container 100. The first nozzle 113 comprises a first inner surface 120 that defines the first passageway 119 and a first outer surface 121.

The first shoulder portion 112 circumferentially surrounds and extends radially outward from the base 127 of the first nozzle 113. The first shoulder portion 112 comprises a first annular edge 122. In the exemplified embodiment, the first annular edge 122 is an annular transverse ledge that circumscribes the first shoulder portion 112, thereby forming a step-like transition between the first shoulder portion 112 and the first product containing portion 111. In other embodiments, the first annular edge 122 may simply be the annular periphery of the first shoulder portion 112. The first annular edge 122 forms a closed-perimeter of the periphery of the first shoulder portion 112. Conceptually, the first annular edge 122 can be thought of as delimiting the first product containing portion 111.

In the exemplified embodiment, the first annular edge 122 has a three-dimensional configuration. Thus, in reference to a Cartesian Coordinate System in which the Y-axis is coincident with the longitudinal axis A1-A1, the first annular edge 122 varies in the Y-direction in addition to forming a closed-perimeter geometry when viewed from the X-Z plane (shown in FIG. 6). More specifically, in the exemplified embodiment, the first annular edge 122 undulates in the Y-direction so as to define peaks 123A-B and valleys 124A-B. In alternate embodiments, the first annular edge 122 may have a substantially two-dimensioned configuration, thereby lying substantially flat within a single plane.

The first product containing portion 111 has a first inner surface 125 and a first outer surface 126. The first inner surface 125 defines the first product cavity 116 while the first outer surface 126 is visible to the user. The first product containing portion 111 has a first three-dimensional geometry which is imparted by a combination of the surface contours of the first outer surface 126 and the shape/silhouette of the first product containing portion 111. In the exemplified embodiment, the first three-dimensional geometry is a slender tubular structure having an oval transverse cross-sectional profile, having a tapered waist at a lower section thereof and a heart-like contouring of the first outer surface 126. Of course, the invention is not so limited and the first three-dimensional geometry can take on a wide variety of embodiments, none of which are limiting of the present invention unless specifically claimed.

The first container body 110 further comprises a first coupling structure 130. The first coupling structure 130 is provided to: (1) operably mate with the first fitment 152 of the first closure 150 to effectuate the desired coupling between the first closure 150 and the first container body 110; and (2) in the alternative, operably mate with the second fitment 252 of the second closure 250 to effectuate the desired coupling between the first closure 150 and the second container body 210. In the exemplified embodiment, the first coupling structure 130 is located on the first nozzle 113. However, in other embodiments, the first coupling structure 130 can be located on the first annular shoulder 112 instead of or in addition to the first nozzle 113. Further, in the exemplified embodiment, the first coupling structure 130 is in the form of a first annular groove 131 and a first annular flange 132 located on the first outer surface 121 of the first nozzle 113. As discussed in greater detail below, the first annular groove 131 and the first annular flange 132 are designed to snap-lock into mating engagement with the first fitment 152. In alternate embodiments, the first coupling structure 130 can take on a wide variety of structures and utilize a wide variety of mechanisms of action to operably mate with the first fitment 152. For example, in certain alternate embodiments, the first coupling structure 150 could comprise threads, tangs, notches, ribs, cam surfaces, cam followers, pins and other structures/assemblies that are known in the art for coupling components together.

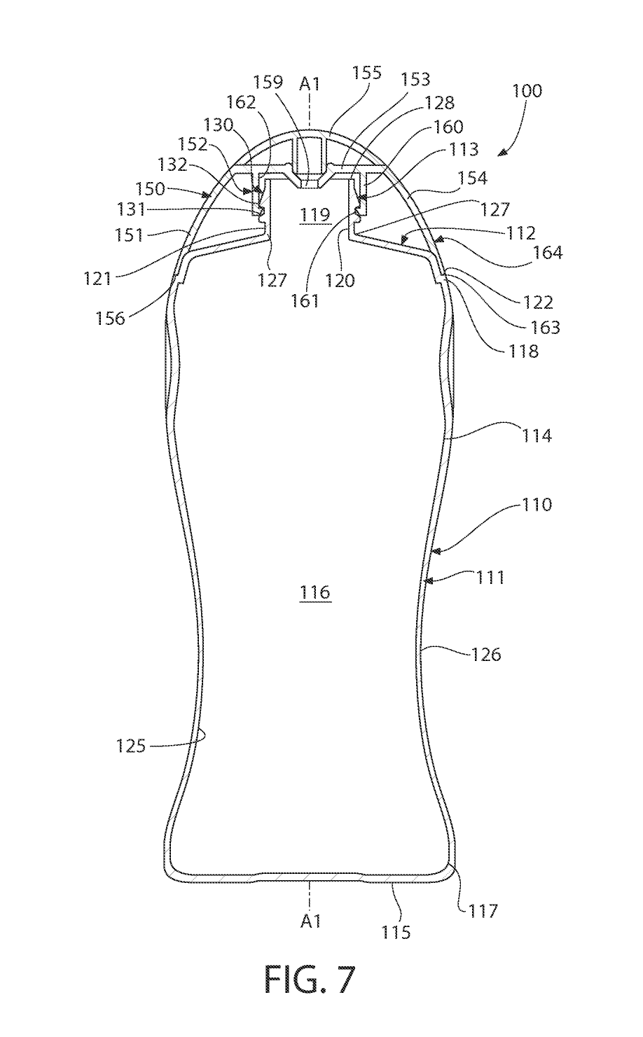

Referring now to FIGS. 1 and 7 concurrently, the structural details of the first closure 150 will be described in greater detail. In one embodiment, the first closure 150 can be constructed of a hard plastic. Suitable hard plastics include polymers and copolymers of ethylene, propylene, butadiene, vinyl compounds and polyesters such as polyethylene terephthalate. Of course, other materials of construction can be utilized as desired.

The first closure 150 generally comprises a first closure body 151 and a first fitment 152. The first closure body 151 has a first outer surface 164. The first closure body 151 has a third three-dimensional geometry which is imparted by a combination of the surface contours of the first outer surface 164 and the shape/silhouette of the first closure body 151. In the exemplified embodiment, the third three-dimensional geometry is a rounded dome-like structure having an oval transverse cross-sectional profile. Of course, the invention is not so limited and the third three-dimensional geometry can take on a wide variety of embodiments, none of which are limiting of the present invention unless specifically claimed.

The first closure body 151 comprises a first closure wall 153, a first annular skirt 154 and a first lid 155. The first closure wall 153 comprises a first dispensing orifice 156. When the first closure 150 is coupled to the first container body 110 to form the first container 100, the first dispensing orifice 159 is in fluid communication with the first passageway 119 of the first nozzle 113 so that the first flowable product within the first product cavity 116 can be dispensed therethrough during use.

The first annular skirt 154 is a tubular structure that extends downward from the first closure wall 153. The first annular skirt 154 terminates in a third annular edge 156. The third annular edge 156 of the first annular skirt 154 has a configuration that is identical to the configuration of the first annular edge 122 of the first shoulder portion 112 of the first container body 110. Thus, in the exemplified embodiment, the third annular edge 156 has a three-dimensional configuration that is identical to the three-dimensional configuration of the first annular edge 122. Similar to the first annular edge 122, the third annular edge 156 varies in the Y-direction in addition to forming a closed-perimeter geometry when viewed from the X-Z plane (using the Cartesian Coordinate System identified in FIG. 6). More specifically, in the exemplified embodiment, the third annular edge 156 undulates in the Y-direction so as to define peaks 157A-B and valleys 158A-B. As with the first annular edge 122, the third annular edge 156 may have a substantially two-dimensioned configuration in certain alternate embodiments, thereby lying substantially flat within a single plane.

The first lid 155 is hingedly coupled to the first closure wall 153 so that the first lid 155 can be alternated between an open position (not shown) in which the first dispensing orifice 159 is open and a closed position (shown in FIG. 1) in which the first dispensing orifice 159 is closed. While the hinge that couples the first lid 155 to the first closure wall 153 is not shown, the hinge may be a traditional pin-slot hinge or a living hinge. Moreover, while the first lid 155 is hingedly coupled to the first closure wall 153 in the exemplified embodiment, the first lid 155 can be hingedly coupled to other portions of the first closure 150 in alternate embodiments. In addition, in other embodiments, the first lid 155 may be coupled to the first closure 150 via snap-fit connection, frictional-fit connection, pivotal connection, slidable connection, and other suitable mechanical coupling means.

In the exemplified embodiment, the first fitment 152 is in the form of an annular tubular structure 160 that circumscribes the first outer surface 121 of the first nozzle 113 when the first closure 150 is coupled to the first container body 110. A first flange 161 protrudes radially inward from a first inner surface 162 of the annular tubular structure 160. The first flange 161 snap-fits into the first groove 131 of the first coupling structure 130 of the first container body 110. The first flange 161 can be an annular flange or can comprise a plurality of circumferentially spaced-apart flange segments. The annular tubular structure 160 can be a continuous annular structure or can be comprised of a plurality of annular segments that are circumferentially spaced-apart from one another. Further, in certain other embodiments, the annular tubular structure 160 can be located within the first nozzle 113 and comprise a radially outward extending flange.

While the first fitment 152 is exemplified as a snap-fit annular structure 160, the invention is not so limited. In alternate embodiments, the first fitment 152 can take the form of threads, tangs, notches, ribs, cam surfaces, cam followers, pins and other structures/assemblies that are known in the art for coupling components together and that would operably mate with the first coupling structure 130.

When the first closure 150 is coupled to the first container body 110 to form the first container 100, the first annular edge 122 and the third annular edge 156 mate with one another and are in substantially continuous surface contact along their lengths. As a result, a first surface contact interface 163 is formed between the first annular edge 122 and the third annular edge 156. Moreover, the first outer surface 164 of the first closure body 151 is substantially flush with the first outer surface 126 of the first product containing portion 111 at the interface 163.

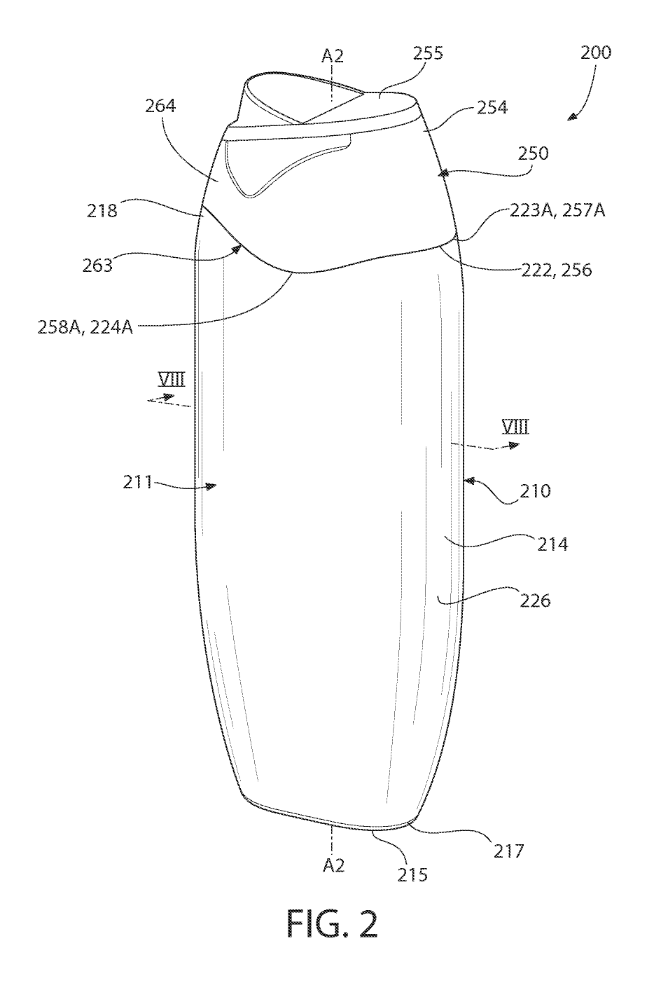

Referring now to FIGS. 2, 5-6 and 8 concurrently, a second container 200 in accordance with one embodiment of the present invention is illustrated. The second container 200 generally comprises a second container body 210 and a second closure 250. The second closure 250 is coupled to the second container body 210 (as described in further detail below) to create the second container 200. In the exemplified embodiment, the second container 200 is a self-standing elongated container that extends along a longitudinal axis A2-A2.

The second container body 210 comprises a second product containing portion 211, a second shoulder portion 212 and a second nozzle 213. In the exemplified embodiment, the second product containing portion 211, the second shoulder portion 212 and the second nozzle 213 are an integrally formed unitary structure. However, in alternate embodiments, the second product containing portion 211, the second shoulder portion 212 and the second nozzle 213 can be formed as one or more separate components that are coupled together at a later stage of manufacturing via a thermal welding, sonic welding, adhesion, tight-fit assembly, or other coupling, fusion and/or bonding process.

The second container body 210 is preferably formed of a thermoplastic, such as polyethylene, polypropylene, polybutylene terephthalate, polyethylene terephthalate, polymethyl methacrylate, polystyrene, and polycarbonate, etc. The second container body 210 can be formed by standard thermoplastic forming techniques, such as blow-molding, injection molding, gas-assist injection molding, or combinations thereof.

The second product containing portion 211 comprises a second upstanding wall 214 and a first lower end wall 215 that, together with the second shoulder portion 212, collectively define a second product cavity 216 in which a second flowable product is stored. The first lower end wall 215 is a substantially flat wall that extends substantially normal to the longitudinal axis A2-A2. As a result, the first lower end wall 215 acts a support surface that allows the second container 200, when positioned on a horizontal surface, to assume a self-supporting upright orientation. The first lower end wall 215 seals a bottom end of the second product cavity 216 so that the second flowable product contained within the second product cavity 216 does not leak therefrom.

The second product containing portion 211 extends from a second lower end 217 to a second upper end 218. The first lower end wall 215 is located at the second lower end 217 of the second product containing portion 211. At the second upper end 218 of second product containing portion 211, the second container body 210 transitions into the second shoulder portion 212. The second shoulder portion 212 extends radially inward from the second upper end 218 of the second product containing portion 211. The second nozzle 213 protrudes from the second shoulder portion 212, extending in a longitudinal direction away from the second product containing portion 211.

The second nozzle 213 is a tubular structure extending from a base 227 to a top edge 228 and defining a second passageway 219 that is in fluid communication with the second product cavity 216. Thus, the second flowable product within the second product cavity 216 can be dispensed through the second passageway 219. In one embodiment, the second upstanding wall 214 of the second product containing portion 211 is compressible radially inward so that the second flowable product can be dispensed from the second container 200. The second nozzle 213 comprises a second inner surface 220 that defines the second passageway 219 and a second outer surface 221.

The second shoulder portion 212 circumferentially surrounds and extends radially outward from the base 227 of the second nozzle 213. The second shoulder portion 212 comprises a second annular edge 222. In the exemplified embodiment, the second annular edge 222 is an annular transverse ledge that circumscribes the second shoulder portion 212, thereby forming a step-like transition between the second shoulder portion 212 and the second product containing portion 211. In other embodiments, the second annular edge 222 may simply be the annular periphery of the second shoulder portion 212. The second annular edge 222 forms a closed-perimeter of the periphery of the second shoulder portion 212. Conceptually, the second annular edge 222 can be thought of as delimiting the second product containing portion 211.

In the exemplified embodiment, the second annular edge 222 has a three-dimensional configuration (and is identical to the first annular edge 122). Thus, in reference to a Cartesian Coordinate System in which the Y-axis is coincident with the longitudinal axis A2-A2, the second annular edge 222 varies in the Y-direction in addition to forming a closed-perimeter geometry when viewed from the X-Z plane (shown in FIG. 6). More specifically, in the exemplified embodiment, the second annular edge 212 undulates in the Y-direction so as to define peaks 223A-B and valleys 224A-B. In alternate embodiments, the second annular edge 222 may have a substantially two-dimensioned configuration, thereby lying substantially flat within a single plane.

The second product containing portion 211 has a second inner surface 225 and a second outer surface 226. The second inner surface 225 defines the second product cavity 216 while the second outer surface 226 is visible to the user. The second product containing portion 211 has a second three-dimensional geometry which is imparted by a combination of the surface contours of the second outer surface 226 and the shape/silhouette of the second product containing portion 211. In the exemplified embodiment, the second three-dimensional geometry is a slender tubular structure having an oval transverse cross-sectional profile, having a tapered bottom end. Of course, the invention is not so limited and the second three-dimensional geometry can take on a wide variety of embodiments, none of which are limiting of the present invention unless specifically claimed. The second three-dimensional geometry of the second product containing portion 211 is different than first three-dimensional geometry of the first product containing portion 111.

The second container body 210 further comprises a second coupling structure 230. The second coupling structure 230 is provided to: (1) operably mate with the first fitment 152 of the first closure 150 to effectuate the desired coupling between the first closure 150 and the second container body 210; and (2) in the alternative, operably mate with the second fitment 252 of the second closure 250 to effectuate the desired coupling between the second closure 250 and the second container body 210. In the exemplified embodiment, the second coupling structure 230 is located on the second nozzle 213. However, in other embodiments, the second coupling structure 230 can be located on the second annular shoulder 212 instead of or in addition to the second nozzle 213. Further, in the exemplified embodiment, the second coupling structure 230 is in the form of a second annular groove 231 and a second annular flange 232 located on the second outer surface 221 of the second nozzle 213. As discussed in greater detail below, the second annular groove 231 and the second annular flange 232 are designed to snap-lock into mating engagement with the second fitment 252. In alternate embodiments, the second coupling structure 230 can take on a wide variety of structures and utilize a wide variety of mechanisms of action to operably mate with the second fitment 252 (or the first fitment 152). For example, in certain alternate embodiments, the second coupling structure 250 could comprise threads, tangs, notches, ribs, cam surfaces, cam followers, pins and other structures/assemblies that are known in the art for coupling components together.

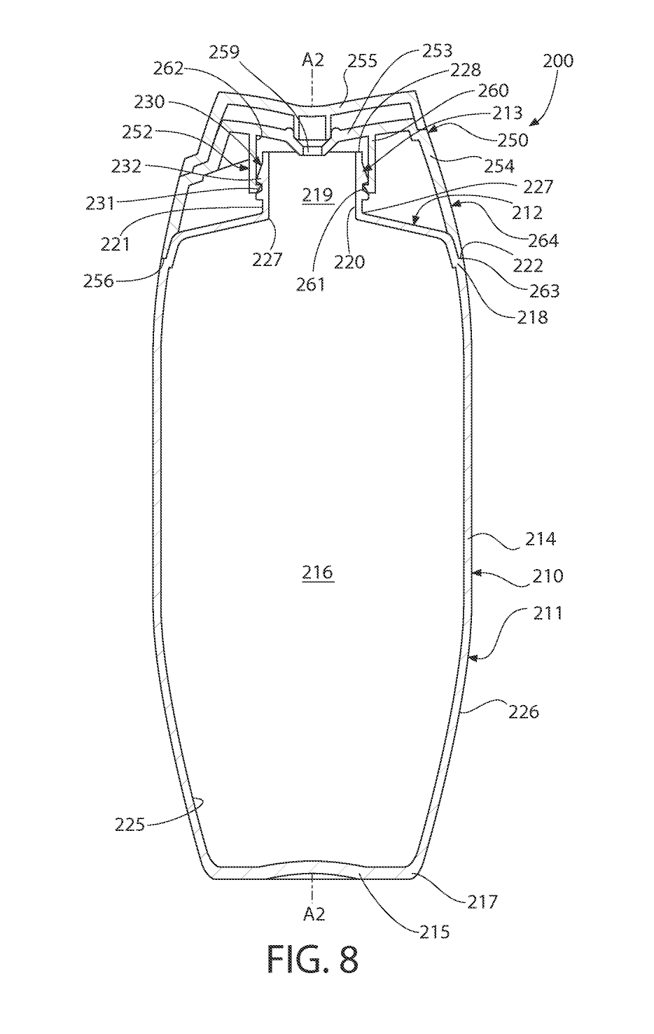

Referring now to FIGS. 2 and 8 concurrently, the structural details of the second closure 250 will be described in greater detail. In one embodiment, the second closure 250 can be constructed of a hard plastic. Suitable hard plastics include polymers and copolymers of ethylene, propylene, butadiene, vinyl compounds and polyesters such as polyethylene terephthalate. Of course, other materials of construction can be utilized as desired.

The second closure 250 generally comprises a second closure body 251 and a second fitment 252. The second closure body 251 has a second outer surface 264. The second closure body 251 has a fourth three-dimensional geometry which is imparted by a combination of the surface contours of the second outer surface 264 and the shape/silhouette of the second closure body 251. In the exemplified embodiment, the fourth three-dimensional geometry is a rounded dome-like structure having a multi-angled planar top surface. Of course, the invention is not so limited and the fourth three-dimensional geometry can take on a wide variety of embodiments, none of which are limiting of the present invention unless specifically claimed.

The second closure body 251 comprises a second closure wall 253, a second annular skirt 254 and a second lid 255. The second closure wall 253 comprises a second dispensing orifice 256. When the second closure 250 is coupled to the second container body 210 to form the second container 200, the second dispensing orifice 259 is in fluid communication with the second passageway 219 of the second nozzle 213 so that the second product within the second product cavity 216 can be dispensed therethrough during use.

The second annular skirt 254 is a tubular structure that extends downward from the second closure wall 253. The second annular skirt 254 terminates in a fourth annular edge 256. The fourth annular edge 256 of the second annular skirt 254 has a configuration that is identical to the configuration of the second annular edge 222 of the second shoulder portion 212 of the second container body 210 (and also identical to the configuration of the first annular edge 122 of the first shoulder portion 112 of the second container body 110 and the configuration of the third annular edge 156 of the first annular skirt 154). Thus, in the exemplified embodiment, the fourth annular edge 212 has a three-dimensional configuration that is identical to the three-dimensional configuration of the second annular edge 222. Similar to the second annular edge 222 (and the first and third annular edges 122, 156), the fourth annular edge 256 varies in the Y-direction in addition to forming a closed-perimeter geometry when viewed from the X-Z plane (using the Cartesian Coordinate System identified in FIG. 6). More specifically, in the exemplified embodiment, the fourth annular edge 256 undulates in the Y-direction so as to define peaks 257A-B and valleys 258A-B. As with the second annular edge 222, the fourth annular edge 256 may have a substantially two-dimensioned configuration in certain alternate embodiments, thereby lying substantially flat within a single plane.

The second lid 255 is hingedly coupled to the second closure wall 253 so that the second lid 255 can be alternated between an open position (not shown) in which the second dispensing orifice 259 is open and a closed position (shown in FIG. 2) in which the second dispensing orifice 259 is closed. While the hinge that couples the second lid 255 to the second closure wall 253 is not shown, the hinge may be a traditional pin-slot hinge or a living hinge. Moreover, while the second lid 255 is hingedly coupled to the second closure wall 253 in the exemplified embodiment, the second lid 255 can be hingedly coupled to other portions of the second closure 250 in alternate embodiments. In addition, in other embodiments, the second lid 255 may be coupled to the second closure 250 via snap-fit connection, frictional-fit connection, pivotal connection, slidable connection, and other suitable mechanical coupling means.

In the exemplified embodiment, the second fitment 252 is in the form of an annular tubular structure 260 that circumscribes the second outer surface 221 of the second nozzle 213 when the second closure 250 is coupled to the second container body 210. A second flange 261 protrudes radially inward from a second inner surface 262 of the annular tubular structure 260. The second flange 261 snap-fits into the second groove 231 of the second coupling structure 230 of the second container body 210. The second flange 261 can be a continuous (i.e., non-segmented) annular flange or can comprise a plurality of circumferentially spaced-apart flange segments. The annular tubular structure 260 can be a continuous annular structure or can be comprised of a plurality of annular segments that are circumferentially spaced-apart from one another. Further, in certain other embodiments, the annular tubular structure 260 can be located within the second nozzle 213 and comprise a radially outward extending flange.

While the second fitment 252 is exemplified as a snap-fit annular structure 260, the invention is not so limited. In alternate embodiments, the second fitment 252 can take the form of threads, tangs, notches, ribs, cam surfaces, cam followers, pins and other structures/assemblies that are known in the art for coupling components together and that would operably mate with the second coupling structure 230.

When the second closure 250 is coupled to the second container body 210 to form the second container 200, the second annular edge 222 and the fourth annular edge 256 mate with one another and are in substantially continuous surface contact along their lengths. As a result, a second surface contact interface 263 is formed between the second annular edge 222 and the fourth annular edge 256. Moreover, the second outer surface 264 of the second closure body 251 is substantially flush with the second outer surface 264 of the second product containing portion 211 at the interface 263.

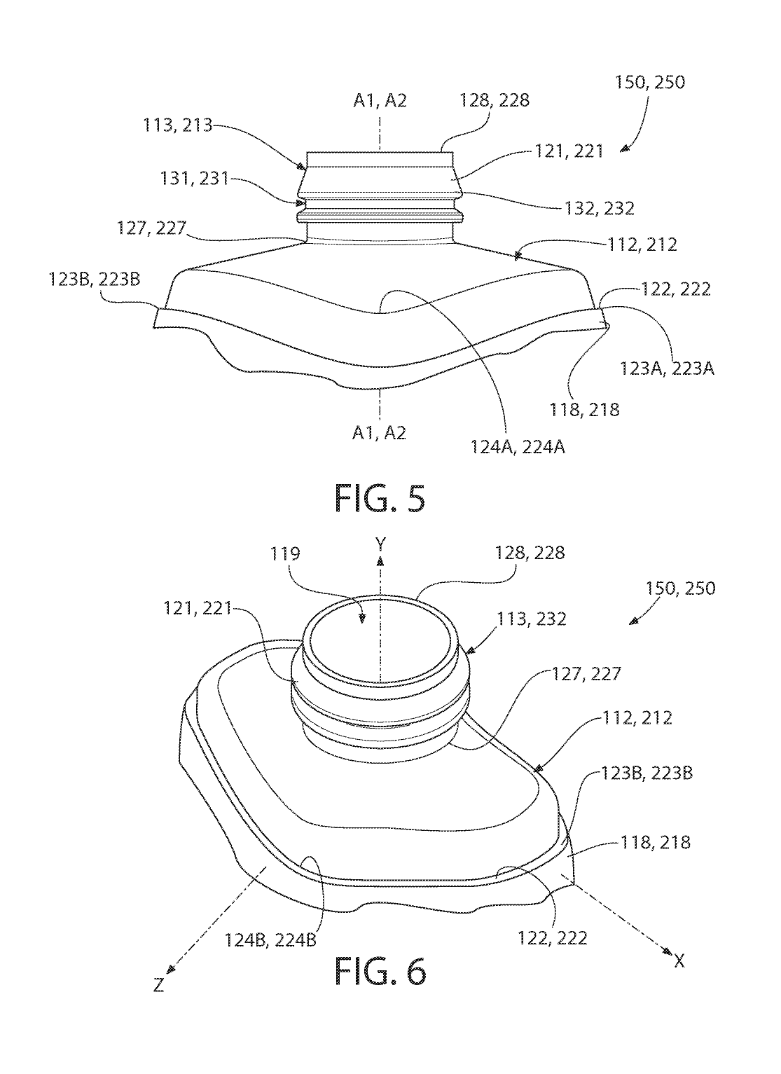

Referring now to FIGS. 5-6 and 7-8 concurrently, it can be seen that both the first container body 110 and the second container body 210 utilize an identical design for the first and second shoulder portions 112, 212. Moreover, the first and second annular edges 122, 222 are also identical to one another (i.e. have an identical three-dimensional configurations). Additionally, the first nozzle 113 of the first container body 110 and the second nozzle 213 of the second container body 210 are also substantially identical to one another. Furthermore, the first and second coupling structures 130, 230 are also substantially identical to one another.

Regarding the first and second closures 150, 250, it can also be seen that the first and second fitments 152, 252 of the first and second closures 150, 250 are also identical to one another. Moreover, the third and fourth annular edges 156, 256 have configurations that are also identical to one another. In fact, the configuration of all of first, second, third and fourth annular edges 122, 222, 156, 256 are substantially identical to one another.

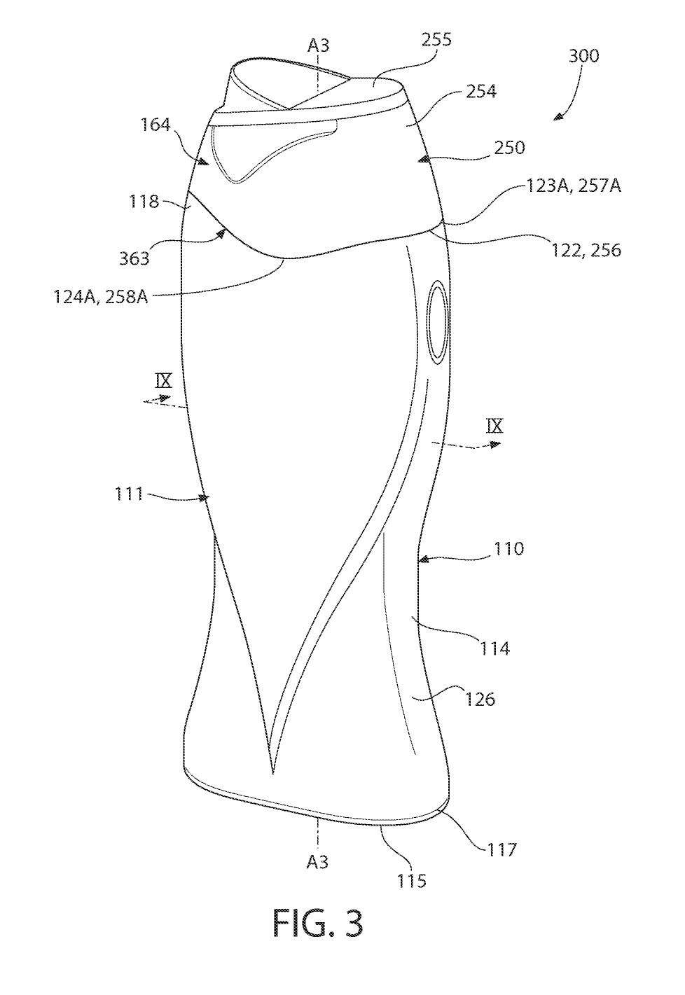

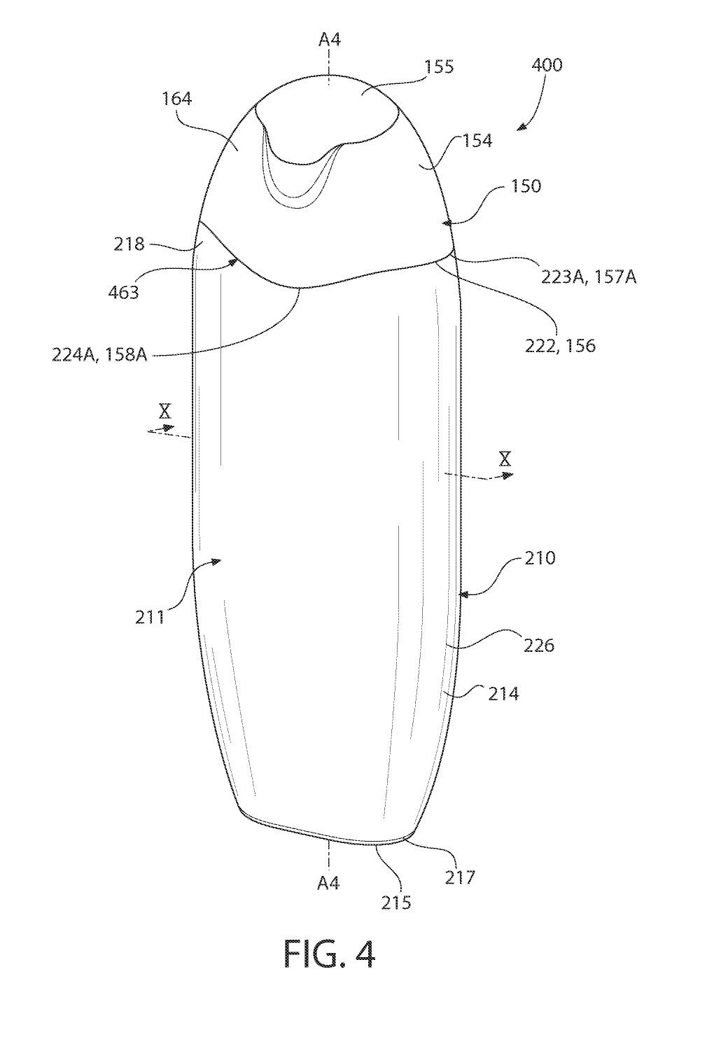

By designing: (1) the configurations of the first, second, third and fourth annular edges 122, 222, 156, 256 identical to one another; (2) the first and second fitments 130, 230 identical to one another; and (3) the first and second coupling structures 130, 230 identical to one another, each of the first and second container bodies 110, 210 can be coupled to each of the different closures 150, 250 to create a total of four containers, all of which have a sleek design that appears to be uniquely designed. Moreover, because each of the first, second and third three-dimensional geometries (discussed above) are different from one another, each of the first, second, third and fourth containers 100, 200, 300 and 400 have a different aesthetic appearance. As discussed above, the first container 100 is achieved by coupling the first container body 110 to the first closure 150 while the second container 200 is achieved by coupling the first container body 210 to the first closure 250. The third container 300 (FIG. 3) is achieved by coupling the first container body 110 to the second closure 250 while the fourth container 400 (FIG. 4) is achieved by coupling the second container body 210 to the first closure 150.

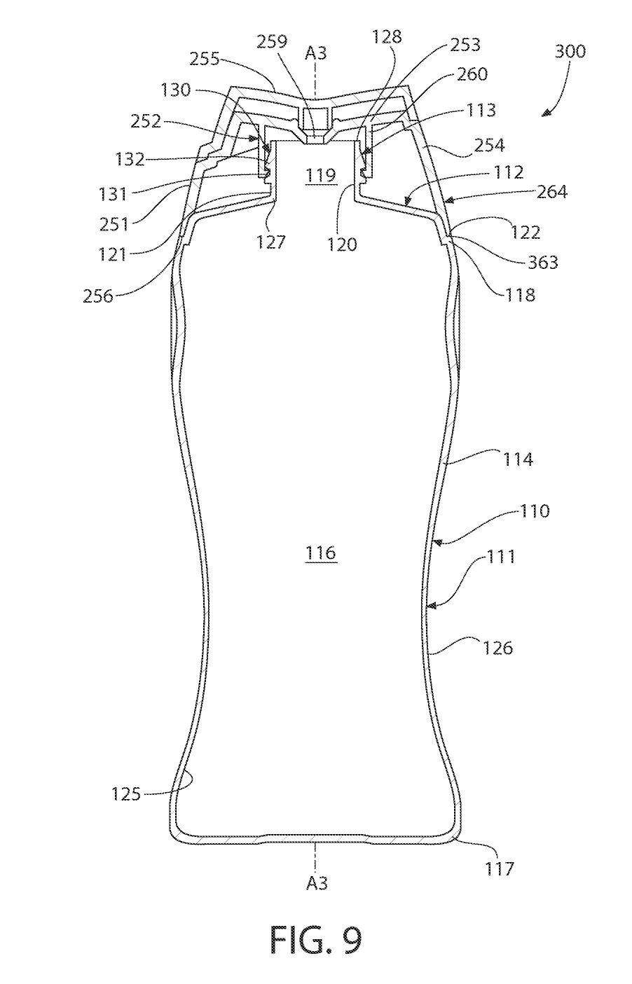

Referring now to FIGS. 3 and 9 concurrently, a third container 300 according to an embodiment of the present invention is illustrated. As mentioned above, the third container 300 is formed by coupling the first container body 110 and the second closure 250 together. This is accomplished by the operable mating of the first coupling structure 130 and the second fitment 230.

Moreover, when the second closure 250 is coupled to the first container body 110 to form the third container 300, the first annular edge 122 and the fourth annular edge 256 mate with one another and are in substantially continuous surface contact along their lengths. As a result, a third surface contact interface 363 is formed between the first annular edge 122 and the fourth annular edge 256. Moreover, the second outer surface 226 of the second closure body 251 is substantially flush with the first outer surface 126 of the first product containing portion 111 at the interface 363. Further, the second dispensing orifice 259 is in fluid communication with the first passageway 119 of the first nozzle 113.

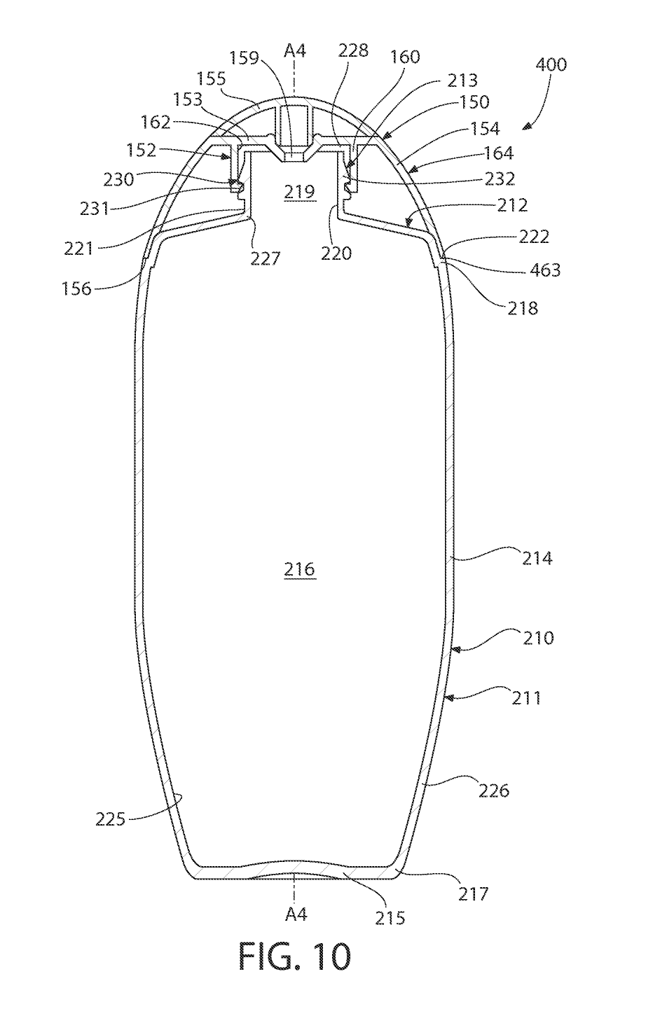

Referring now to FIGS. 4 and 10 concurrently, a fourth container 400 according to an embodiment of the present invention is illustrated. As mentioned above, the fourth container 400 is formed by coupling the second container body 210 and the first closure 150 together. This is accomplished by the operable mating of the second coupling structure 230 and the first fitment 130.

Moreover, when the first closure 150 is coupled to the second container body 210 to form the fourth container 400, the second annular edge 222 and the third annular edge 156 mate with one another and are in substantially continuous surface contact along their lengths. As a result, a fourth surface contact interface 463 is formed between the second annular edge 222 and the third annular edge 156. Moreover, the first outer surface 164 of the first closure body 151 is substantially flush with the second outer surface 226 of the second product containing portion 211 at the interface 463. Further, the first dispensing orifice 159 is in fluid communication with the second passageway 219 of the first nozzle 213.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the foregoing description and drawings represent the exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A system of containers having interchangeable components comprising:
a first container body comprising: a first product containing portion; a first shoulder portion having a first annular edge; and a first nozzle;
a second container body comprising: a second product containing portion;
a second shoulder portion having a second annular edge; and a second nozzle;
a first closure comprising: a first closure body; and a first fitment, the first closure body comprising: a first closure wall having a first dispensing orifice; a first lid; and a first annular skirt terminating in a third annular edge;
a second closure comprising: a second closure body; and a second fitment, the second closure body comprising: a second closure wall having a second dispensing orifice; a second lid; and a second annular skirt terminating in a fourth annular edge;
each of the first product containing portion, the second product containing portion, the first closure body, and the second closure body having a three-dimensional geometry that is different from one another; and each of the first, second, third, and fourth annular edges having a configuration that is substantially identical to one another;
the first fitment configured to: (1) couple the first closure to the first container body so that the first and third annular edges mate with one another and the first dispensing orifice is in fluid communication with a passageway of the first nozzle, thereby creating a first container; and (2) in the alternative, couple the first closure to the second container body so that the second and third annular edges mate with one another and the first dispensing orifice is in fluid communication with a passageway of the second nozzle, thereby creating a second container; and
the second fitment configured to: (1) couple the second closure to the first container body so that the first and fourth annular edges mate with one another and the second dispensing orifice is in fluid communication with the passageway of the first nozzle, thereby creating a third container; and (2) in the alternative, couple the second closure to the second container body so that the second and fourth annular edges mate with one another and the second dispensing orifice is in fluid communication with the passageway of the second nozzle, thereby creating a fourth container.

2. The system according to claim 1 wherein the configuration of the first, second, third and fourth annular edges is a three-dimensional contour.

3. The system according to claim 1 wherein the first nozzle comprises a first coupling structure that can operably mate with the first fitment to couple the first closure to the first container body and, in the alternative, operably mate with the second fitment to couple the second closure to the first container body; and wherein the second nozzle comprises a second coupling structure that can operably mate with the first fitment to couple the first closure to the second container body and, in the alternative operably mate with the second fitment to couple the second closure to the second container body.

4. The system according to claim 3 wherein the first and second coupling structures are substantially identical to one another.

5. The system according to claim 3 wherein each of the first and second coupling structures comprises a groove and a flange.

6. The system according to claim 1 wherein the first and second fitments are substantially identical to one another.

7. The system according to claim 1 wherein the first annular skirt extends downward from the first closure wall and the second annular skirt extends downward from the second closure wall.

8. The system according to claim 1 wherein the first and second shoulder portions are substantially identical to one another.

9. The system according to claim 1 wherein the first and second nozzles are substantially identical to one another.

10. The system according to claim 1 wherein each of the first and second fitments comprises a tubular sleeve having a flange protruding from an inner surface of the tubular sleeve.

11. The system according to claim 1 wherein the first annular edge is a first transverse ledge formed into the first shoulder portion and the second annular edge is a second transverse ledge formed into the second shoulder portion.

12. The system according to claim 1 further comprising:
wherein for the first container, an outer surface of the first annular skirt is substantially flush with an outer surface of the first product containing portion at an interface formed between the first annular edge and the third annular edge;
wherein for the second container, the outer surface of the first annular skirt is substantially flush with an outer surface of the second product containing portion at an interface formed between the second annular edge and the third annular edge;
wherein for the third container, an outer surface of the second annular skirt is substantially flush with the outer surface of the first product containing portion at an interface formed between the first annular edge and the fourth annular edge; and
wherein for the fourth container, the outer surface of the second annular skirt is substantially flush with the outer surface of the second product containing portion at an interface formed between the second annular edge and the fourth annular edge.

13. The system according to claim 1 wherein the first, second, third and fourth annular edges form a closed perimeter when viewed from an X-Z plane of a Cartesian coordinate system and undulate in a Y-direction of the Cartesian coordinate system.

14. A system of containers having interchangeable components comprising:
a first container body comprising: a first product containing portion having a first three-dimensional geometry; and a first nozzle;
a second container body comprising: a second product containing portion having a second three-dimensional geometry; and a second nozzle;
a first closure comprising: a first closure body having a third three-dimensional geometry; and a first fitment;
a second closure comprising: a second closure body having a fourth three-dimensional geometry; and a second fitment;
each of the first, second, third and fourth three-dimensional geometries being different from one another;
the first fitment configured to: (1) couple the first closure to the first container body to create a first container; and (2) in the alternative, couple the first closure to the second container body to create a second container; and
the second fitment configured to: (1) couple the second closure to the first container body to create a third container; and (2) in the alternative, couple the second closure to the second container body to create a fourth container.

15. The system according to claim 14 wherein the first and second fitments are substantially identical to one another.

16. The system according to claim 14 further comprising:
wherein the first nozzle comprises a first coupling structure that can operably mate with the first fitment to couple the first closure to the first container body and, in the alternative, operably mate with the second fitment to couple the second closure to the first container body; and
wherein the second nozzle comprises a second coupling structure that can operably mate with the first fitment to couple the first closure to the second container body and, in the alternative operably mate with the second fitment to couple the second closure to the second container body.

17. The system according to claim 16 wherein the first and second coupling structures are substantially identical to one another.

18. The system according to claim 14 further comprising:
wherein for the first container, an outer surface of the first closure body is substantially flush with an outer surface of the first product containing portion at an interface formed between the first closure body and the first product containing portion;
wherein for the second container, the outer surface of the first closure body is substantially flush with an outer surface of the second product containing portion at an interface formed between the first closure body and the second product containing portion;
wherein for the third container, an outer surface of the second closure body is substantially flush with the outer surface of the first product containing portion at an interface formed between the second closure body and the first product containing portion; and
wherein for the fourth container, the outer surface of the second closure body is substantially flush with the outer surface of the second product containing portion at an interface formed between the second closure body and the second product containing portion.

19. The system according to claim 14 further comprising:
wherein the first container body further comprises a first shoulder portion having a first annular edge;
wherein the second container body further comprises a second shoulder portion having a second annular edge;
wherein the first closure body further comprises a first annular skirt terminating in a third annular edge;
wherein the second closure body further comprises a second annular skirt terminating in a fourth annular edge; and
wherein each of the first, second, third, and fourth annular edges have a three-dimensional configuration that is substantially identical to one another;

20. The system according to claim 14 further comprising:
wherein the first closure body further comprises a first dispensing orifice and a first lid for opening and closing the first dispensing orifice; and
wherein the second closure body further comprises a second dispensing orifice and a second lid for opening and closing the second dispensing orifice.

21. A system of containers having interchangeable components comprising:
a first container body comprising: a first product containing portion having a first three-dimensional geometry; and a first coupling structure;
a second container body comprising: a second product containing portion having a second three-dimensional geometry; and a second coupling structure that is substantially identical to the first coupling structure;
a first closure comprising: a first closure body having a third three-dimensional geometry; and a first fitment;
a second closure comprising: a second closure body having a fourth three-dimensional geometry; and a second fitment that is substantially identical to the first coupling structure; and
each of the first, second, third and fourth three-dimensional geometries being different from one another; and
wherein each of the first and second fitments can be coupled to each of the first and second coupling structures.

22. The system according to claim 21 wherein the first and second closures can be coupled to the first and second container bodies to create four different containers.

23. The system according to claim 22 further comprising:
wherein for a first container, an outer surface of the first closure body is substantially flush with an outer surface of the first product containing portion at an interface formed between the first closure body and the first product containing portion;
wherein for a second container, the outer surface of the first closure body is substantially flush with an outer surface of the second product containing portion at an interface formed between the first closure body and the second product containing portion;
wherein for a third container, an outer surface of the second closure body is substantially flush with the outer surface of the first product containing portion at an interface formed between the second closure body and the first product containing portion; and
wherein for a fourth container, the outer surface of the second closure body is substantially flush with the outer surface of the second product containing portion at an interface formed between the second closure body and the second product containing portion.

24. The system according to claim 21 further includes
a first nozzle comprising the first coupling structure; and
a second nozzle comprising the second coupling structure.

25. The system according to claim 21 further comprising:
wherein the first container body further comprises a first shoulder portion having a first annular edge;
wherein the second container body further comprises a second shoulder portion having a second annular edge;
wherein the first closure body further comprises a first annular skirt terminating in a third annular edge;
wherein the second closure body further comprises a second annular skirt terminating in a fourth annular edge; and
wherein each of the first, second, third, and fourth annular edges have a three-dimensional configuration that is substantially identical to one another;

26. The system according to claim 24 further comprising:
wherein the first container body further comprises a first dispensing orifice and a first lid for opening and closing the first dispensing orifice; and
wherein the second container body further comprises a second dispensing orifice and a second lid for opening and closing the second dispensing orifice.

27. A method of manufacturing a container comprising:
a) providing a plurality of first container bodies comprising: a first product containing portion having a first three-dimensional geometry; a first nozzle, and a first coupling structure;
b) providing a plurality of second container bodies comprising: a second product containing portion having a second three-dimensional geometry; a second nozzle; and a second coupling structure;
c) providing a plurality of first closures comprising: a first closure body having a third three-dimensional geometry; and a first fitment;
d) providing a plurality of second closures comprising: a second closure body having a fourth three-dimensional geometry; and a second fitment; wherein each of the first, second, third and fourth three-dimensional geometries are different from one another; and
e) coupling one of the first and second closures to one of the first and second container bodies via operable mating between the first or second fitment and the first or second coupling structure to form a container.

28. The method according to claim 27 wherein the first and second fitments are substantially identical to one another and the first and second coupling structures are substantially identical to one another.

29. The method according to claim 27 further comprising:
wherein upon completion of step e), an outer surface of the first or second closure body is substantially flush with an outer surface of the first or second product containing portion at an interface formed between the first or second closure body and the first or second product containing portion.

30. The method according to claim 27 wherein the first nozzle comprises the first coupling structure and the second nozzle comprises the second coupling structure.

31. The method according to claim 27 wherein:
each one of the first container bodies comprises a first shoulder portion having a first annular edge;
each one of the second container bodies to further comprise a second shoulder portion having a second annular edge;
each one of the first closure bodies to further comprise a first annular skirt terminating in a third annular edge;
each one of the second closure bodies to further comprise a second annular skirt terminating in a fourth annular edge; and
wherein each of the first, second, third, and fourth annular edges have a three-dimensional configuration that is substantially identical to one another.

32. The method according to claim 31 wherein coupling one of the first or second closures to one of the first or second container bodies further comprises mating one of the first and second annular edges with one of the third and fourth annular edges.

33. The method according to claim 27 further comprising:
forming the first closure body to further comprise a first dispensing orifice and a first lid for opening and closing the first dispensing orifice; and
forming the second closure body to further comprise a second dispensing orifice and a second lid for opening and closing the second dispensing orifice.
